(19) United States
(12) Patent Application Publication
(10) Pub. No.: US 2009/0134773 A1
(43) Pub. Date: May 28, 2009

(54) Color pixel element for field emission display

(75) Inventors: Yang Wei, Beijing (CN); Liang Liu, Beijing (CN); Shou-Shan Fan, Beijing (CN)

Correspondence Address: PCE INDUSTRY, INC.;ATT. Steven Reiss, 458 E. LAMBERT ROAD, FULLERTON, CA, 92835, US

(73) Assignees: Tsinghua University, Beijing City (CN); Hon Hai Precision Industry Co., Ltd, Tu-Cheng City (TW)

(21) Appl. No.: 12/069,313

(22) Filed: Feb. 8, 2008

(30) Foreign Application Priority Data
Nov. 23, 2007 (CN) 200710124775.X

(51) Int. Cl. H01J 1/62

(52) U.S. Cl. 313/495

(57) ABSTRACT

A color pixel element for field emission display includes a sealed container having a light permeable portion, at least two anodes, a cathode, at least two phosphor layers formed on the end surfaces of the anodes, and at least two CNT strings electrically connected to and in contact with the cathode with the emission portions of the CNT strings suspending. The phosphor layers are opposite to the light permeable portion, and one emission portion is corresponding to one phosphor layer. In each CNT string, some of CNT bundles are taller than and project over the adjacent CNT bundles, and each of projecting CNT bundles functions as an electron emitter. The anodes, the cathode, the phosphor layers and the CNT strings are enclosed in the sealed container. The luminance of the color pixel element is enhanced at a relatively low voltage.

### RELATED APPLICATIONS

This application is related to commonly-assigned, co-pending application: U.S. patent application Ser. No. ______, entitled “PIXEL TUBE FOR FIELD EMISSION DISPLAY”, filed ______ (Atty. Docket No. US16665) and U.S. patent application Ser. No. ______, entitled “METHOD FOR MANUFACTURING FIELD EMISSION ELECTRON SOURCE HAVING CARBON NANOTUBE”, filed ______ (Atty. Docket No. US16786). The disclosure of the respective above-identified application is incorporated herein by reference.

### BACKGROUND

1. Field of the Invention

The invention relates to color pixel elements and, particularly, to a color pixel element for field emission display.

2. Discussion of Related Art

Field emission displays (FEDs) are based on emission of electrons in vacuum. Electrons are emitted from micron-sized tips in a strong electric field, and the electrons are accelerated and collide with a fluorescent material, and then the fluorescent material emits visible light. FEDs are thin, light weight, and provide high levels of brightness.

Carbon nanotubes (CNTs) produced by means of arc discharge between graphite rods were first discovered and reported in an article by Sumio Iijima, entitled “Helical Microtubules of Graphitic Carbon” (Nature, Vol. 354, Nov. 7, 1991, pp. 56-58). CNTs also feature extremely high electrical conductivity, very small diameters (much less than 100 nanometers), large aspect ratios (i.e. length/diameter ratios) (greater than 1000), and a tip-surface area near the theoretical limit (the smaller the tip-surface area, the more concentrated the electric field, and the greater the field enhancement factor). These features tend to make CNTs ideal candidates for electron emitter in FED. Generally, a color pixel element of the FED includes a number of CNTs acting as electron emitters. However, single CNT is so tiny in size and then the controllability of the method of manufacturing is less than desired. Further, the luminous efficiency of the FED is low due to the shield effect caused by the adjacent CNTs.

What is needed, therefore, is a color pixel element for FED, which has high luminous efficiency and can be easily manufactured.

### SUMMARY

A color pixel element for field emission display includes a sealed container having a light permeable portion, at least two anodes, a cathode, at least two phosphor layers formed on the end surfaces of the anodes, and at least two CNT strings electrically connected to and in contact with the cathode with the emission portions of the CNT strings suspending. The phosphor layers are opposite to the light permeable portion, and one emission portion is corresponding to one phosphor layer. In each CNT string, some of CNT bundles are taller than and project over the adjacent CNT bundles, and each of projecting CNT bundles functions as an electron emitter. The anodes, the cathode, the phosphor layers and the CNT strings are enclosed in the sealed container.

Compared with the conventional color pixel element, the present color pixel element has the following advantages: using CNT string as the electron emitter, and thus the color pixel element is more easily fabricated. Further, the emission portion of the CNT string is in a tooth-shape structure, which can prevent from the shield effect caused by the adjacent CNT bundles, and the luminous efficiency of the color pixel element is improved.

Other advantages and novel features of the present color pixel element will become more apparent from the following detailed description of preferred embodiments when taken in conjunction with the accompanying drawings.

### BRIEF DESCRIPTION OF THE DRAWINGS

Many aspects of the present color pixel element can be better understood with reference to the following drawings. The components in the drawings are not necessarily to scale, the emphasis instead being placed upon clearly illustrating the principles of the present color pixel element.

FIG. 1 is a schematic, isometric view of a color pixel element according to an embodiment.

FIG. 2 is a schematic, top-sectional view of a color pixel element according to an embodiment.

FIG. 3 is a schematic, side-sectional view of a part of the color pixel element according to an embodiment.

FIG. 4 is a schematic, amplificatory view of part 125 in FIG. 1.

FIG. 5 is a Scanning Electron Microscope (SEM) photo, showing part 125 in FIG. 1.

FIG. 6 is a Transmission Electron Microscope (TEM) photo, showing part 125 in FIG. 1.

Corresponding reference characters indicate corresponding parts throughout the several views. The exemplifications set out herein illustrate at least one preferred embodiment of the color pixel element, in one form, and such exemplifications are not to be construed as limiting the scope of the invention in any manner.

### DETAILED DESCRIPTION OF PREFERRED EMBODIMENTS

Reference will now be made to the drawings to describe the preferred embodiments of the present color pixel element for a field emission display, in detail.

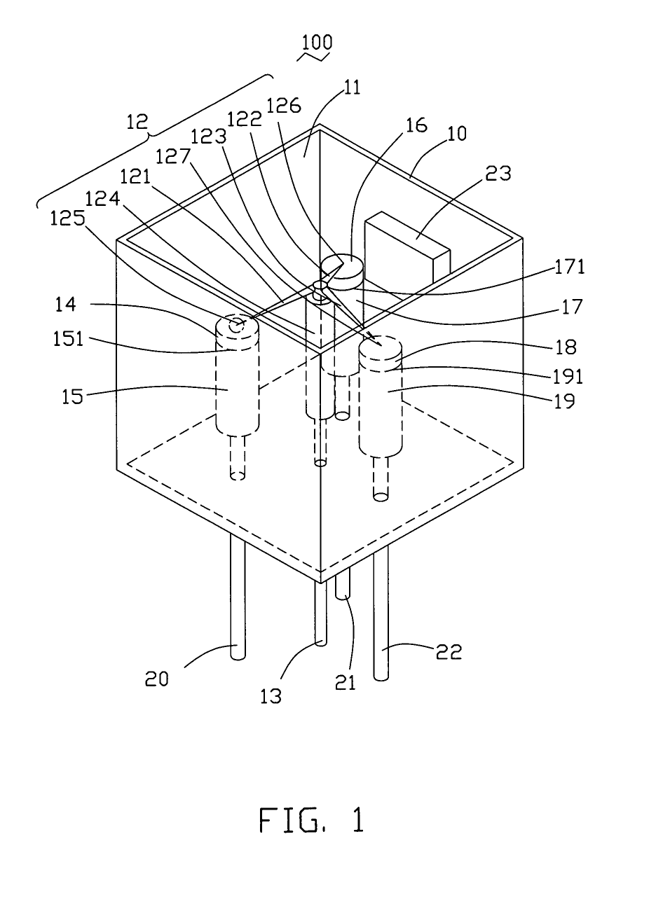

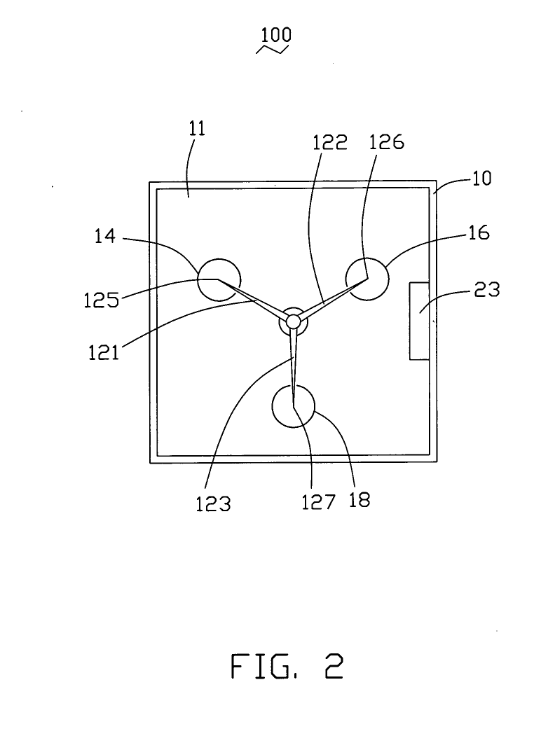

Referring to FIGS. 1 and 2, a color pixel element 100 for a FED includes a sealed container 10 having a light permeable portion 11, a cathode 124, three CNT strings 121, 122 and 123, three anodes 15, 17 and 19, three phosphor layers 14, 16 and 18, a cathode terminal 13 and three anode terminals 20, 21 and 22. The cathode 124, the CNT strings 121, 122 and 123, the anodes 15, 17 and 19, the phosphor layers 14, 16 and 18 are all enclosed in the sealed container 102. The cathode 124, the anodes 15, 17 and 19, the cathode terminal 13, and three anode terminals 20, 21 and 22 are made of thermally and electrically conductive materials.

The cathode 124 is electrically connected to the cathode terminal 13, and the anodes 15, 17 and 19 are respectively electrically connected to the anode terminals 20, 21 and 22. The cathode terminal 124, and the anode terminals 20, 21 and 22 run from the inside to the outside of the sealed container 10.

The sealed container 10 is a hollow member that defines an inner space in vacuum. The cross section of the sealed container 10 has a shape selected from a group consisting of circular, ellipsoid, quadrangular, triangular, polygonal and so on. The sealed container 10 may be comprised of any nonmetallic material, and the emission portion 11 need be made of a transparent material. In the present embodiment, the sealed container 10 is a hollow cylinder and comprised of quartz or glass. A diameter of the sealed container 10 is about 2-10 millimeters (mm), and a height thereof is about 5-50 mm. The light permeable portion 11 has a surface selected from the group consisting of a plane surface, a spherical surface and an aspherical surface.

The anodes 15, 17 and 19 are made of metal materials. The distances between the cathode 124 and the anodes 15, 17 and 19 are substantially equal, and the distances therebetween are in an approximate range of 10 μm to 2 mm. Further, the space among the anodes 15, 17 and 19 are beneficially equal. The anode 15 has an end surface 151, the anode 17 has an end surface 171, and the anode 19 has an end surface 191. The phosphor layers 14, 16 and 18 with a thickness of about 5-50 microns (μm) are formed on the corresponding end surfaces 151, 171 and 191. The phosphor layer 14 is a red phosphor layer, the phosphor layer 16 is a green phosphor layer and the phosphor layer 18 is a blue phosphor layer. The end surface 151, 171 and 191 are polished metal surfaces or plated metal surfaces, and thus can reflect the light beams emitted from the phosphor lays 14, 16 and 18 to the permeable portion 11 to enhance the brightness of the color pixel element 100.

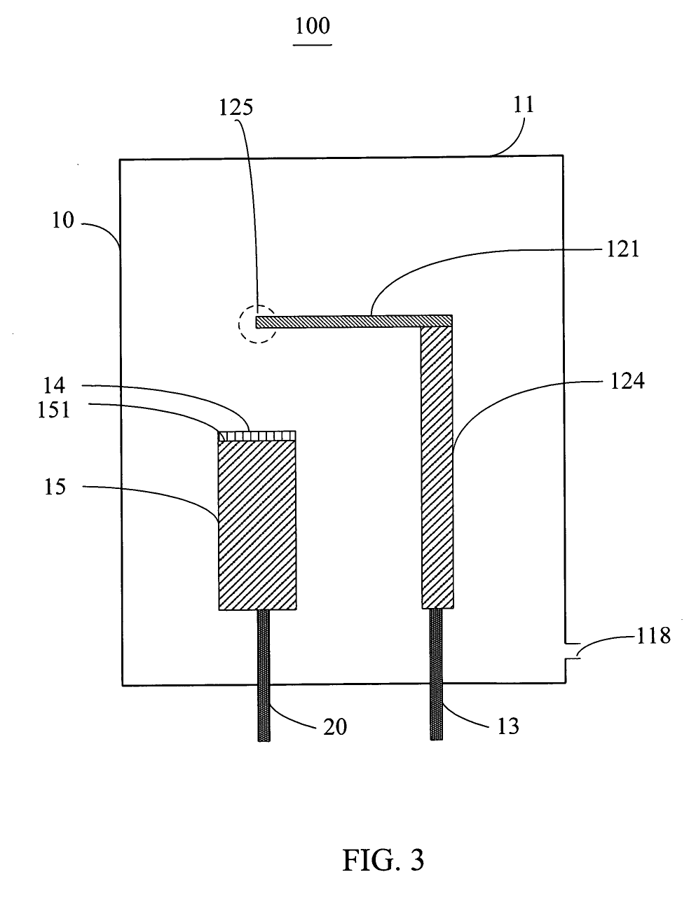

In the present embodiment, three CNT strings 121, 122 and 123, and three anodes 15, 17 and 19 have the same structures. Thus, the CNT string 121 and the anode 15 are described for an example as the following. Referring to FIG. 3, the CNT string 121 is electrically connected to and in contact with the cathode 124 by a conductive paste, such as silver paste, with an emission portion 125 of the CNT string 121 suspending. The phosphor layer 14 is opposite to the light permeable portion 11, and the emission portion 125 is corresponding to the phosphor layer 14. A distance between the emission portion 125 and the phosphor layer 14 is less than 5 mm. The emission portion 125 can be arranged perpendicular to the phosphor layer 14, parallel to phosphor layer 14 or inclined to phosphor layer 14 with a certain angle. In the present embodiment, the emission portion 125 is parallel to phosphor layer 14, and arranged between the phosphor layer 14 and the light permeable portion 11. The cathode 124 is made of an electrically conductive material, such as nickel, copper, tungsten, gold, molybdenum or platinum.

The CNT string 121 is composed of a number of closely packed CNT bundles, and each of the CNT bundles includes a number of CNTs, which are substantially parallel to each other and are joined by van der Waals attractive force. A diameter of the CNT string 121 is in an approximate range from 1 to 100 microns (μm), and a length thereof is in an approximate range from 0.1-10 centimeters (cm).

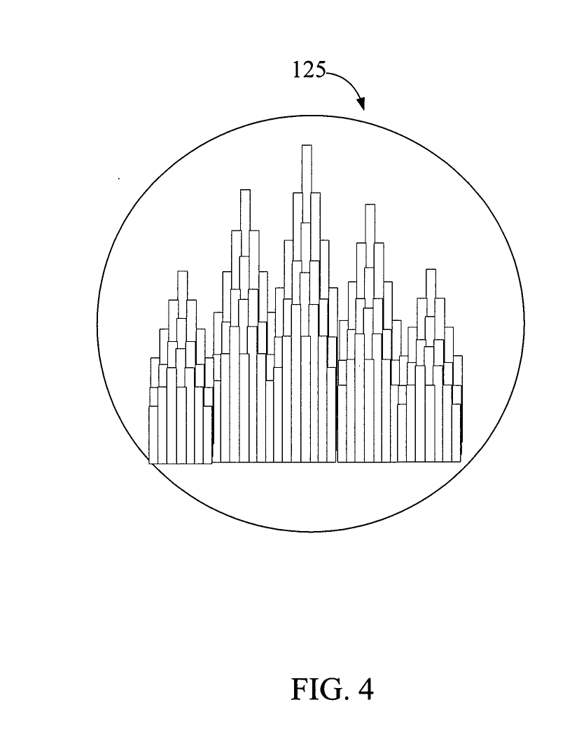

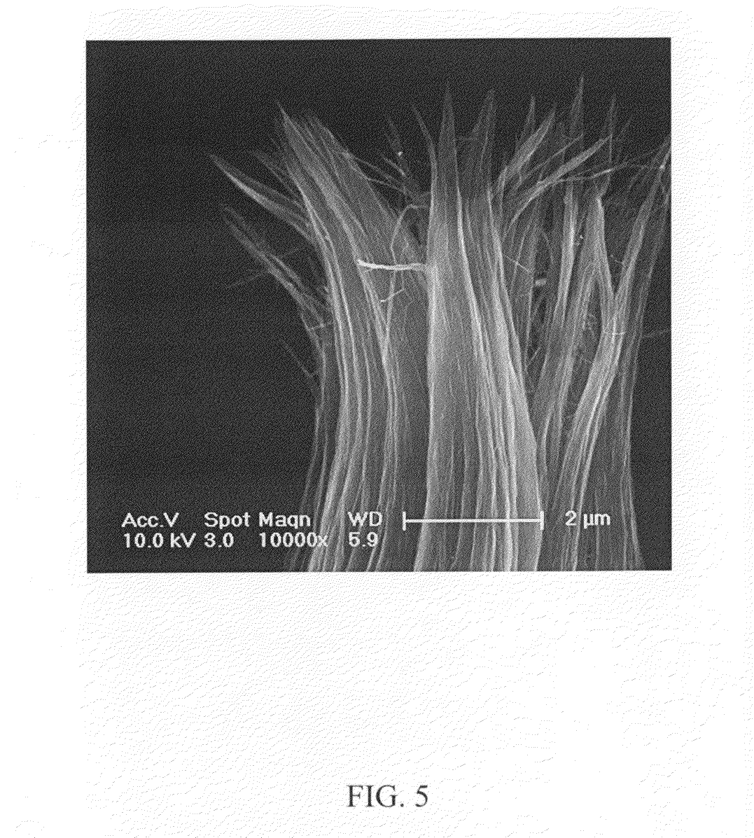

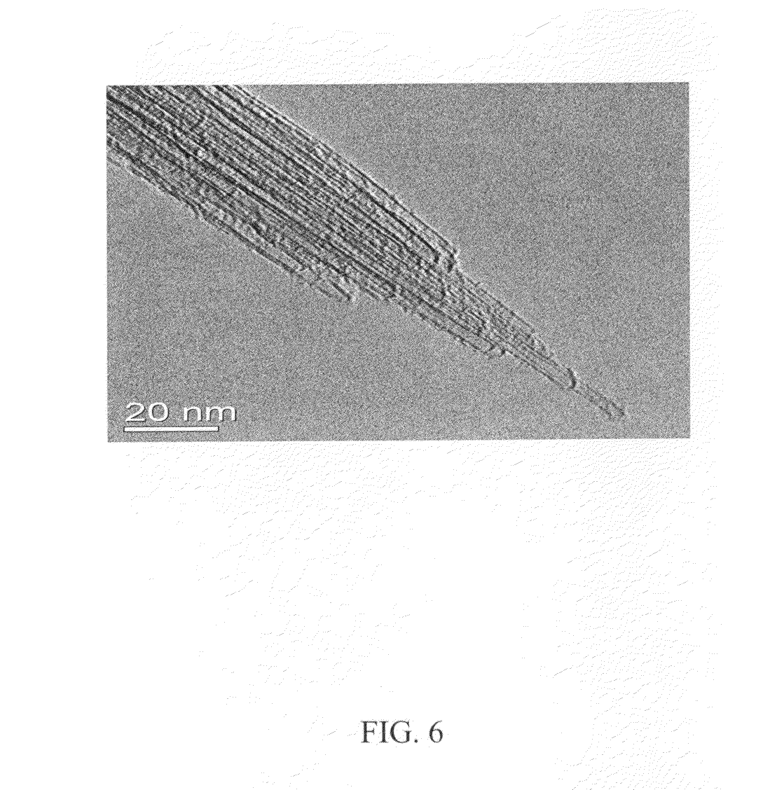

Referring to FIGS. 4, 5 and 6, the CNTs at the emission portion 125 form a tooth-shaped structure, i.e., some of CNT bundles being taller than and projecting above the adjacent CNT bundles. Therefore, a shield effect caused by the adjacent CNTs can be reduced. The field emission efficiency of the CNT string 121 is improved. The CNTs at the emission portion 125 have smaller diameter and fewer number of graphite layer, typically, less than 5 nanometer (nm) in diameter and about 2-3 in wall. However, the CNTs in the CNT string 121 other than the emission portion 125 are about 15 nm in diameter and more than 5 in wall.

A method for making the CNT string 121 is taught in U.S. Application No. US16663 entitled “METHOD FOR MANUFACTURING FIELD EMISSION ELECTRON SOURCE HAVING CARBON NANOTUBES”, which is incorporated herein by reference. The CNT string can be drawing a bundle of CNTs from a super-aligned CNT array to be held together by van der Waals force interactions. Then, the CNT string is soaked in an ethanol solvent, and thermally treated by supplying a current thereto. After the above processes, the CNT string 121 has improved electrical conducting and mechanical strength.

In operation, a voltage is applied between the cathode 124 and the anode 15, an electric field is formed therebetween, and electrons are emanated from the emission portion 125 of the CNT string 121. The electrons transmit toward the anode 15, hit the phosphor layer 14, and the visible red light beams are emitted from the phosphor layer 14. One part of the light beams transmits through the light permeable portion 11, another part is reflected by the end surface 151 and then transmits out of the light permeable portion 11. Using the CNT string 121, the luminance of the color pixel element 100 is enhanced at a relatively low voltage. By adjusting the voltages applied to the anodes 15, 17 and 19, the color pixel element 100 can emit any kinds of color light beam, such as white, yellow.

The color pixel element 100 may further includes a getter 23 configured for absorbing residual gas inside the sealed container 10 and maintaining the vacuum in the inner space of the sealed container 10. More preferably, the getter 23 is arranged on an inner surface of the sealed container 10. The getter 23 may be an evaporable getter introduced using high frequency heating. The getter 23 also can be a non-evaporable getter.

The color pixel element 100 may further includes an air vent 118. The air vent 118 can be connected with a gas removal system (not shown) such as, for example, a vacuum pump for creating a vacuum inside the sealed container 10. The color pixel element 100 is evacuated to obtain the vacuum by the gas removal system through the air vent 118, and then sealed. A number of color pixel elements 100 can be easily assembled into a large-area FED.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A color pixel element for field emission display comprising:
a sealed container having a light permeable portion;
a cathode;
at least two anodes;
at least two phosphor layers, each phosphor layer formed on an end surface of the corresponding anode, the phosphor layers opposite to the light permeable portion;
at least two CNT strings electrically connected to and in contact with the cathode with each emission portion of the CNT strings suspending, each emission portion corresponding to one phosphor layer, wherein in each CNT string, some of CNT bundles being taller than and projecting over the adjacent CNT bundles, and each of projecting CNT bundles functioning as an electron emitter;
the anodes, the cathode, the phosphor layers and the CNT strings being enclosed in the sealed container.

2. The color pixel element for field emission display as claimed in claim 1, wherein each emission portion is arranged between the corresponding phosphor layer and the light permeable portion.

3. The color pixel element for field emission display as claimed in claim 1, wherein a diameter of each CNT string is in an approximate range from 1 to 100 microns, and a length of each CNT string is in an approximate range from 0.1-10 centimeters.

4. The color pixel element for field emission display as claimed in claim 1, wherein each CNT string is composed of a plurality of closely packed CNT bundles, each of the CNT bundles comprises a plurality of CNTs, the CNTs are substantially parallel to each other and are joined by van der Waals attractive force.

5. The color pixel element for field emission display as claimed in claim 4, wherein the CNTs at the emission portion have a diameter of less than 5 nanometers and a number of graphite layer of about 2-3.

6. The color pixel element for field emission display as claimed in claim 4, wherein the CNTs in the CNT string other than the emission portion have a diameter of about 15 nanometers and a number of graphite layer of more than 5.

7. The color pixel element for field emission display as claimed in claim 1, further comprising at least two anode terminal and a cathode terminal, wherein the anode terminals are electrically connected to the corresponding anodes, and the cathode terminal is electrically connected to the cathode respectively.

8. The color pixel element for field emission display as claimed in claim 7, wherein the anode terminal and the cathode terminal run from the inside to the outside of the sealed container.

9. The color pixel element for field emission display as claimed in claim 1, wherein the cathode, the anodes, the cathode terminal and the anode terminals are made of thermally and electrically conductive materials.

10. The color pixel element for field emission display as claimed in claim 9, wherein the anodes are made of metal materials, and the end surfaces of the anodes are polished metal surfaces or plated metal surfaces.

11. The color pixel element for field emission display as claimed in claim 1, wherein the sealed container is a hollow member that defines an inner space in vacuum.

12. The color pixel element for field emission display as claimed in claim 1, wherein the sealed container is comprised of quartz or glass.

13. The color pixel element for field emission display as claimed in claim 1, wherein a diameter of the sealed container is about 1-5 millimeters, and a height thereof is about 2-5 millimeters.

14. The color pixel element for field emission display as claimed in claim 1, wherein the light permeable portion has a surface selected from the group consisting of a plane surface, a spherical surface and an aspherical surface.

15. The color pixel element for field emission display as claimed in claim 1, wherein the CNT strings are electrically connected to and in contact with the cathode by conductive paste.

16. The color pixel element for field emission display as claimed in claim 1, wherein the emission portions of the CNT strings are suspending.

17. The color pixel element for field emission display as claimed in claim 1, wherein a distance between the emission portion of the CNT string and the corresponding phosphor layer is less than 5 millimeters.

18. The color pixel element for field emission display as claimed in claim 1, wherein the emission portions are arranged perpendicular to the phosphor layers, parallel to phosphor layers or inclined to phosphor layers with a certain angle.

19. The color pixel element for field emission display as claimed in claim 1, further comprising a getter, wherein the getter is arranged on an inner surface of the sealed container.

20. The color pixel element for field emission display as claimed in claim 1, wherein the distances between the cathode and the anodes are about 10 μm to about 2 mm and the spaces among the anodes are substantially equal.
